(19) United States
(12) Patent Application Publication
(10) Pub. No.: US 2020/0263842 A1
(43) Pub. Date: Aug. 20, 2020

(54) LIGHTING SYSTEM

(71) Applicant: AVID Labs, LLC, Fort Wayne, IN (US)

(72) Inventors: Joel A. Nichols, Columbia City, IN (US); Keersten E. Nichols, Columbia City, IN (US)

(73) Assignee: AVID Labs, LLC, Fort Wayne, IN (US)

(21) Appl. No.: 16/794,872

(22) Filed: Feb. 19, 2020

Related U.S. Application Data
(60) Provisional application No. 62/807,360, filed on Feb. 19, 2019.

(51) Int. Cl. F21S 4/20

(52) U.S. Cl. CPC F21S 4/20; F21Y 2103/10

(57) ABSTRACT

A lighting system that includes an extrusion that is generally Y-shaped having two arms and a mounting portion, and a light strip inserted between the two arms, the light strip being oriented to emit light outward in a general direction that bisects an angle between the arms.

### CROSS REFERENCE TO RELATED APPLICATIONS

This is a non-provisional application based upon U.S. provisional patent application Ser. No. 62/807,360, entitled “LIGHTING SYSTEM”, filed Feb. 19, 2019, which is incorporated herein by reference.

### BACKGROUND OF THE INVENTION

### 1. Field of the Invention

The present invention relates to a lighting system that has a light unit inserted in an extrusion having a mounting protrusion.

### 2. Description of the Related Art

A Light Emitting Diode (LED) Strip Light (also known as an LED tape, a tape light or ribbon light) is generally a linear flexible circuit board populated by surface mounted devices (SMD) in the form of LEDs and other components that often come with an adhesive backing. Originally, strip lights were used solely in accent lighting, backlighting, task lighting, and decorative lighting applications. With the increased luminous efficacy of higher-power LEDs, strip lights are now used in applications such as high brightness task lighting, and as fluorescent and halogen lighting fixture replacements.

Tape light is widely available and becoming a common commodity product in the LED lighting industry. The product is both cost effective and easy to install. The product is very versatile and can be cut to the correct length with ease and no additional tools. Tape light is available in indoor configurations, weather and waterproof versions, color changing versions and comes in variable widths normally between 8 and 15 mm.

Securing tape light is usually achieved using an adhesive backing with a cover that is removed and the product stuck down to the end use item. In certain situations, a mechanical means of securing is required, in these instances the tape light is normally held down using a crimp that straddles the top of the tape. In yet another instance a cover and channel may be used to secure the tape. Some projects require all three.

For installation of integrated lights typically fasteners are applied to mounting clips and the lighting is clipped thereinto. Also, some integrated lighting systems have laterally extending tabs through which fasteners are driven flush with the underlying surface.

What is needed in the art is a way to allow the use of strip lighting to form a light system that can be manufactured in an economic manner, allowing the quick insertion into an extrusion and for efficient positioning in a building.

### SUMMARY OF THE INVENTION

Embodiments of the present invention include a lighting system having a Y-shaped extrusion.

The invention in one form is directed to a lighting system that includes an extrusion that is generally Y-shaped having two arms and a mounting portion, and a light strip inserted between the two arms, the light strip being oriented to emit light outward in a general direction that bisects an angle between the arms.

The invention in another form is directed to a lighting system including an extrusion that is generally Y-shaped having two arms and a mounting portion, and a light strip inserted between the two arms, the mounting portion being coupled to a building member.

Advantageously, the present invention provides a lighting system that may be easily attached to a building structural member.

Additional features and advantages of the invention will be made apparent from the following detailed description of illustrative embodiments that proceeds with reference to the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a plan exploded view illustrating an embodiment of a lighting system of the present invention;

FIG. 2 is an end view illustrating an end of the extrusion and cross section thereof of the lighting system of FIG. 1; and

FIG. 3 is another end view of the lighting system of FIGS. 1 and 2.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

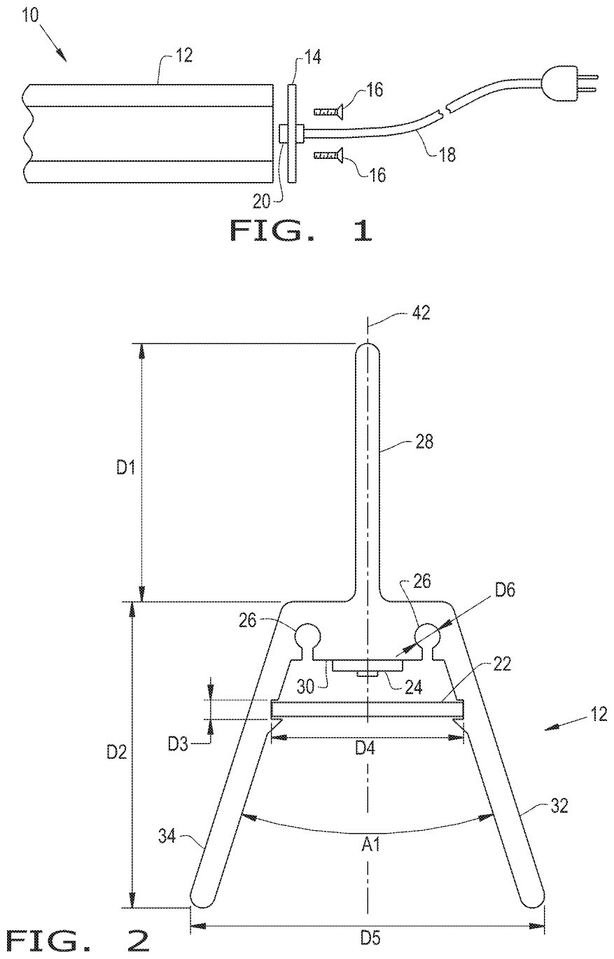

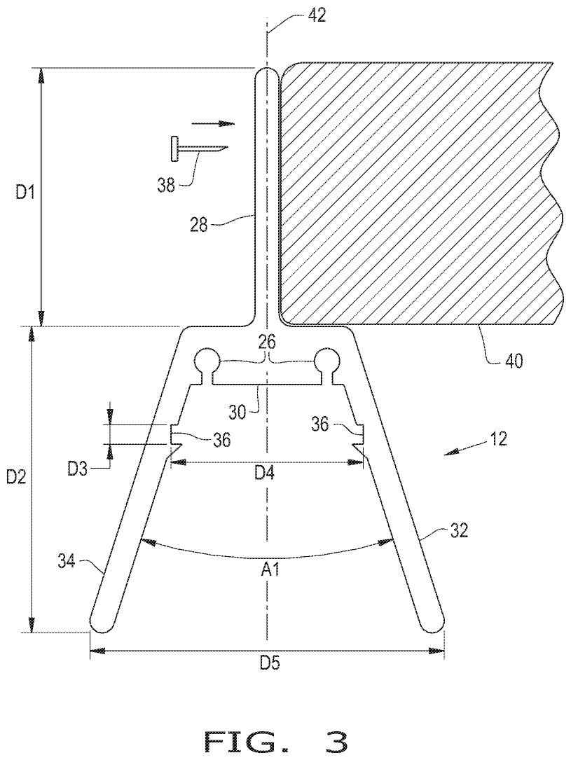

Referring now to the drawings, and more particularly to FIG. 1, there is shown a lighting system 10 including a light member 12, an end plate 14, fasteners 16, an electrical connection 18 and an electrical interface 20. Light member 12 is an elongated member having a cross section illustrated in FIGS. 2 and 3. Light member 12 may be made of an extrusion and may be of various lengths. The material of the extrusion may be plastic, metal or other extrudable material.

End plate 14 is coupled to member 12 with fasteners 16. Electrical connection 18, which is illustrated as an electrical cord, can be in the form of wiring, or a connector plug to facilitate end-to-end coupling of another system 10. Electrical connection 18 is coupled to plate 14 and there can be electrical interface 20, which can rectify, regulate and pass on electrical energy to a light strip 24 (illustrated in FIG. 2).

Additionally referring to FIGS. 2 and 3, further details of light member 12 are illustrated looking at an end profile of member 12. A clear or translucent member 22 allows light from light strip 24 to pass through, while it protects light strip 24 from damage. Member 22 can also function as a light diffuser. Light strip 24 is shown in the form of a strip of LED lights on a tape that is adhered to a flat area of a structural portion 30. Channels 26 have a keyhole shape and are used to accommodate screws 16 that secure end plate 14 to member 12. Structural portions 28, 30, 32 and 34 are integrally formed with each other. Structural portion 28 can be considered a mounting portion having a length D1, which can be 1.38 inches, which corresponds to the width of a 2×4 stud. Structural portions 32 and 34 extend from structural portion 30 a distance D2, which can be approximately 1.63 inches. Structural portions 32 and 34 are angularly arranged at an angle A1, which can be approximately 35 degrees. Structural portions 28, 30, 32 and 34 have a general Y-shape or is generally Y-shaped with a lateral extension 30 connected to arms 32 and 34. Structural portions 32 and 34 each have a groove 36 that has a width D3, which is approximately 0.10 inches, and grooves 36 are spaced apart a distance D4 of approximately 1 inch. Grooves 36 accommodate and hold member 22 away from light 22. Structural portions 32 and 34 have distal ends that are apart from each other a distance D3, which can be approximately 1.84 inches. The diameter D6 of the hole portion of channels 26 has an approximate value of 0.13 inches.

Fasteners 38 can be used to fasten light system 10 to a building member 40, such as a 2×4 building member 40. While not shown, there can be holes in portion 28 to accommodate the fastening of member 12 to member 40.

Light member 12 of lighting system 10 is integrally formed as an extrusion that is generally Y-shaped having two arms 32, 34 and a mounting portion 28. Light strip 24 is inserted between arms 32, 34, and light strip 24 is oriented to emit light outward in a general direction that bisects angle A1 between the arms, generally shown as an axis 42. Lateral extension 30 is connected to arms 32, 34 and mounting portion 28.

Light strip 24 is coupled to lateral extension 30, as shown in FIG. 2. Also, as can be seen in FIGS. 2 and 3, lateral extension 30 is perpendicular to mounting portion 28. The extrusion of light member 12 has a cross-sectional shape that is substantially symmetric about axis 42. Light strip 24 is approximately centered relative to axis 42. Further, light strip 24 is an LED light emitting tape 24 adhered to lateral extension 30.

Extrusion 12 has two keyhole slots 26 that run along a length of extrusion 12. Mounting portion 28 is oriented to be coupled to building member 40, with mounting portion 28 having a length D1 that approximates the width of the building member 40 in the form of a 2×4. Preferably the height D1 of mounting portion 28 is selected to work with both sides of a 2×4 or 2×6 piece of wood 40. Using either side of member 40, light system 10 does not protrude beyond the distal edge of building member 40. Arms 32, 34 each include a groove 36 facing each other, the grooves of the two arms accommodate clear/translucent member 22. Further, it is also contemplated that each arm 32, 34 can have a lateral protrusion (not shown) facing outward. The lateral protrusion is approximately perpendicular to axis 42 and is spaced from building member 40 so that an edge of drywall can be inserted therebetween, so that extrusion 12 provides a finished look when a finishing material, such as drywall is applied to building member 40.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A lighting system, comprising:
an extrusion that is generally Y-shaped having two arms and a mounting portion; and
a light strip inserted between the two arms, the light strip being oriented to emit light outward in a general direction that bisects an angle between the arms.

2. The lighting system of claim 1, further comprising a lateral extension that is connected to the arms and the mounting portion.

3. The lighting system of claim 2, wherein the light strip is coupled to the lateral extension.

4. The lighting system of claim 2, wherein the lateral extension is perpendicular to the mounting portion.

5. The lighting system of claim 4, wherein the extrusion has a cross-sectional shape that is substantially symmetric about an axis.

6. The lighting system of claim 5, wherein the light strip is approximately centered relative to the axis.

7. The lighting system of claim 5, wherein the light strip is an LED light emitting tape adhered to the lateral extension.

8. The lighting system of claim 1, wherein the extrusion has two keyhole slots that run along a length of the extrusion.

9. The lighting system of claim 1, wherein the mounting portion is oriented to be coupled to a building member.

10. The lighting system of claim 9, wherein the mounting portion has a length that approximates the width of the building member in the form of a 2×4.

11. The lighting system of claim 1, wherein the arms each include a groove facing each other, the grooves of the two arms accommodate a clear/translucent member.

12. A lighting system, comprising:
an extrusion that is generally Y-shaped having two arms and a mounting portion; and
a light strip inserted between the two arms, the mounting portion being coupled to a building member.

13. The lighting system of claim 12, further comprising a lateral extension that is connected to the arms and the mounting portion, the light strip being coupled to the lateral extension.

14. The lighting system of claim 13, wherein the lateral extension is perpendicular to the mounting portion.

15. The lighting system of claim 14, wherein the extrusion has a cross-sectional shape that is substantially symmetric about an axis.

16. The lighting system of claim 15, wherein the light strip is approximately centered relative to the axis.

17. The lighting system of claim 12, wherein the extrusion has two keyhole slots that run along a length of the extrusion.

18. The lighting system of claim 12, wherein the mounting portion has a length that approximates the width of the building member in the form of a 2×4.

19. The lighting system of claim 1, wherein the arms each include at least one of a groove facing each other and a lateral protrusion facing outward.

20. The lighting system of claim 19, wherein the grooves of the two arms accommodate a clear/translucent member inserted therein.
